(19) United States
(12) Patent Application Publication
(10) Pub. No.: US 2008/0281690 A1
(43) Pub. Date: Nov. 13, 2008

(54) METHOD, SYSTEM AND COMPUTER PROGRAM FOR PROVIDING A LOYALTY ENGINE FOR DYNAMIC ADMINISTRATION OF CHARITY DONATIONS

(76) Inventors: Terrence Patrick Tietzen, Edmonton (CA); Ronald James MacKay, Edmonton (CA); Timothy Makoto Yamamoto, Edmonton (CA)

Correspondence Address: MILLER THOMPSON, LLP, Scotia Plaza, 40 King Street West, Suite 5800, TORONTO, ON, M5H 3S1, CA

(21) Appl. No.: 11/746,502

(22) Filed: May 9, 2007

(51) Int. Cl. G06Q 30/00; G06Q 90/00

(52) U.S. Cl. 705/14

(57) ABSTRACT

A method, system and computer program for providing a loyalty engine enabling dynamic administration of charity donations is provided. The method includes a merchant creating by operation of the loyalty engine a customized loyalty program defined by a plurality of rules for administering their loyalty program; the operator of the loyalty engine registers one or more charities on the loyalty engine; the merchant also defines on the loyalty engine the rules under which, as part of their loyalty program, they will make a donation to the one or more charities in connection with one or more transactions with a member that is associated to the loyalty program; the member optionally selects, as part of their participation in the loyalty program, the one or more charities to whom the merchant shall make a donation based on transactions between the member and merchant, and further based on the applicable rules defined by the merchant. The loyalty engine tracks applicable transactions, applies the donation rules, accrues the applicable donations. The loyalty engine can also be provided with a transaction utility that is operable to process donation payments between the merchants and the charities. A system is also provided that consists of the loyalty engine, including a charity utility that provides the functions of the method, linked to a server computer that is connected to the Internet. The computer program of the invention is a web application that enables the members, charities, and merchants to access the functions of the invention via a browser. A reporting facility is also described that allows merchants, charities and members to track their donation activity in connection with the operation of the loyalty engine.

### FIELD OF THE INVENTION

This invention relates to creation and administration of loyalty reward programs. This invention relates more particularly to creation and administration of loyalty programs linked to charitable donations.

### BACKGROUND OF THE INVENTION

Numerous customer loyalty and customer acquisition programs are known. Customer acquisition systems also play an increasingly important role for business.

Linking charitable organizations with customer loyalty and customer acquisition is known.

For example, COMMUNITY SMART™ makes credit cards available, wherein specified donations are made to a charity of the customer's choice.

Other examples include KIDS FUTURES™ and UPROMISE™. These prior art solutions provide co-branded financial cards with a charity as a partner, which are issued to a customer who uses it and the charity shares in the applicable interchange fees.

It should be understood that in this disclosure the term “merchant” refers to an entity who participates in a loyalty program to build loyalty with customers, and potentially acquire new business, and in exchange is willing to provide a loyalty “benefit” (e.g. cash, in kind contribution, special reduction in price, donation to a charity, or other promotion). A “member” refers to the customer or potential customer who is a member of the loyalty program referred to.

One of the disadvantages of these prior art solutions is the lack of flexibility in the manner in which transactions triggering donations to the charity must occur. The benefit that a merchant participating in a loyalty program is willing to provide will depend on a particular merchant and their business objectives at a particular time. The prior art solutions do not enable merchants to suitably reflect these changing objectives in the manner in which donations are processed in the context of the loyalty program. For example, a merchant that earmarks certain funds for charitable donations and is reaching the end of its reporting period with unspent funds for charity may have a limited time to boost its donations. The merchant might prefer to make donations in the context of a loyalty program, however, prior art systems do not enable merchants to enhance their donation contributions under the loyalty system to such an end.

In addition, the prior art solutions generally are linked to one particular charity, or the choices of the member are “locked in” with a particular charity in the context of the loyalty program. This limits the choice of the member and therefore limits the desirability of the loyalty program to potential members overall, and furthermore restricts the members' behaviour who might, for example, want to respond to a particular need of a charity at a particular time (e.g. at the time of a major funding drive, or of a shortfall of a charity during a critical time period).

Therefore there is a need for a loyalty program linked to charitable donations that allows the participation of multiple merchants, and the flexibility that enables the charity benefit to be maximized by responding to changing business objectives. There is a further need for a loyalty program that enables multiple merchants to reflect their changing business objectives by dynamically modifying the rules of the loyalty program as they relate to charitable donations. More specifically, there is a need for a loyalty program that enables merchants to customize their loyalty program, including as it related to charitable donations, on the fly, including based on effectiveness and incremental cost.

There is also a need for a loyalty program with benefits to charity that permits the participation of multiple charities therefore attracting more members by means of promotion of the loyalty program by the charities, and further that provides control to members in terms of how the charitable benefit of their activities within the loyalty program is apportioned between a plurality of participating charities.

Many charities have important profile and very significant donor lists. This profile and these donor lists have not generally been leveraged to the benefit of a loyalty program because charities are reluctant to associate their goodwill with a loyalty program, in many cases in large part because the loyalty program lacks transparency to the members in that they cannot readily track the relationship between their activities within the loyalty program and the donations made to the charity.

There is a further need for a loyalty program that enables members to obtain data regarding their activities within the loyalty program that are eligible for charitable donations and also regarding donations made on their behalf to charity by members.

The level of contribution that merchants would be willing to provide to a charity in the context of a loyalty program have been limited in part because prior art solutions did not adequately address the need for business to verify the commercial benefit derived by the merchants. Related charitable donations could be increased if the merchants were given the tools to measure and monitor the effectiveness and incremental cost of their activities involving charitable donations. There is a need therefore for a method, system and computer program that enables merchants to monitor and verify the commercial benefit that they are deriving from the charitable donations, thereby encouraging the merchants to increase their charitable donations.

Another factor that has contributed to reluctance of both merchants and charities to participate in the type of activity described above, and thereby depriving themselves of the mutual benefits, is the fact that most prior art solutions involve (in the context of the particular loyalty program) association with a limited number of merchants with a single or small number of charities (usually with different purposes). Merchants are concerned of alienating at least some of their customer base, for example by associating with one charity but not another charity favoured by a part of their customer base. Similarly, charities are loathe to bring attention to the fact that they are associating with one merchant, but not a competing merchant, for example, favoured by a number of their donors. This aspect is exacerbated by increased competition for donations by charities, and also the polarization that exists sometimes between the respective customer bases of companies that are highly competitive with one another (especially where comparative advertising is used). There is a further need for a method, system and computer program that addresses this disadvantage by permitting a merchant to associate with a plurality of charities (including charities with similar purposes), and charities to associate loosely with a plurality of merchants, where the members determine by selecting one or more charities and then engaging in consumer behaviour associated with a loyalty program associated with a plurality of merchants, ultimately determine the donations flowing from the merchants to the charity. A system whereby the member controls the flow of donations and therefore maintains the freedom of choice of the member tends to be affected by this particular disadvantage to a lesser degree.

Co-Pending Canadian Application No. 2,468,386, filed on May 27, 2004, describes a “Method, System, and Computer Program for Providing a Loyalty Engine Enabling Dynamic Administration of Cross-Promotional Loyalty Programs (the “Co-Pending Patent Application”). The Co-Pending Patent Application generally describes a system, method and computer programs that permits dynamic interactions between a plurality of merchants and a plurality of members. In the particular, the solution described in the Co-Pending Patent Application enables the merchants to dynamically customize loyalty programs based on effectiveness and incremental cost. There is a particular need for a method, system and computer program that enables the relationship between members and charities to be leveraged in the context of a loyalty program and in a manner that addresses the aforesaid needs.

### SUMMARY OF INVENTION

A method, system and computer program is provided that enables a loyalty program to be linked to charitable donations, involving a loyalty program platform or loyalty engine or loyalty system. The loyalty program platform provides to a plurality of merchants tools to customize one or more loyalty programs made available to members of the loyalty program platform (customer and potential customers of the merchants). The operator of the loyalty program platform establishes relationships with one or more charities, such relationships determining certain rules under which the plurality of merchants may make donations to the one or more charities based on the activities of members in connection with the loyalty programs. By operation of the loyalty engine, the operator and each participating merchant establish rules for each participating merchant to make donations to the one or more charities, in conformity with the rules established between the operator and the one or more charities. The loyalty program platform operator in provides members the option of selecting one or more charities from a list of charities provided by the loyalty program platform. The loyalty system applies the aforementioned rules as they apply to each participating member so as to process donations based on their applicable transactions within the loyalty system. The loyalty program platform enables each of the merchants, members and charities to track the donation activity.

In one particular aspect of the present invention, the present invention provides a method, system and computer program for enabling a loyalty program linked to charitable donations, in which charitable donations are increased overall by enabling participating merchants to adjust the parameters of their charitable donations to their business objectives at the time by permitting the merchants to dynamically modify the rules of the loyalty program as they relate to charitable donations. More specifically, the method, system and computer program in accordance with this aspect enables merchants to customize their loyalty program dynamically, including as it relates to charitable donations, based on effectiveness and incremental cost. This generally results in enhanced donation levels to the participating charities.

In another aspect of the present invention, the method, system and computer program for providing a loyalty program linked to charitable donations provides transparency by enabling them to track donations made to the one or more charities of their choice, thereby encouraging charity and member participation.

In yet another aspect of the present invention, a method, system and computer program for providing a loyalty program linked to charitable donations is provided that permits a merchant to associate with a plurality of charities (including charities with similar purposes), and charities to associate loosely with a plurality of merchants, where the members, by selecting one or more charities and then by engaging in consumer behaviour in connection with a loyalty program associated with a plurality of merchants, ultimately determine the donations flowing from the merchants to the charity.

In a still other aspect of the present invention, a method, system and computer program for providing a loyalty program linked to charitable donations is provided that is based on the method, system and computer program described in the Co-Pending Patent Application. Specifically, registration of members to the loyalty program platform involves members providing financial card data for one or more financial cards of each of the one or more participants, and financial data is collected corresponding to transactions between the members and merchants, said financial data being provided to a loyalty engine that is part of the loyalty program platform. The loyalty engine includes a charity utility that is operable to administer a charity account for each member who has selected one or more participating charities to receive donations from merchants. The charity utility is thereby operable to track transactions between members and merchants and credit the charity account with an applicable charitable donation credit, to the name of the applicable charity or charities. The operator of the loyalty program platform, or its agent, on a periodic basis processes donations from the applicable merchants to the applicable charities based on the information in the charity account.

In another method for providing a loyalty program linked to charitable donations including the steps of: Each of a plurality of merchants creating a customized loyalty program defined by a plurality of rules for administering their loyalty program; a) linking one or more charities with the loyalty programs; b) the plurality of merchants defining the rules under which, as part of their loyalty program, they will make a donation to one or more charities in connection with one or more transactions with a member that is associated to the loyalty program (donation rules); c) the member optionally selecting one or more charities presented to the member that, as part of their participation in the loyalty program, the plurality of merchants shall make a donation to the selected charities in connection with transactions between the member and the plurality of merchants; and i) tracking the transactions subject to the member's selection, applying the donation rules, and making the applicable donations available to the one or more charities.

In yet another system for providing a loyalty program presented by a plurality of merchants to a plurality of members registered with the loyalty program, the loyalty program being linked to charitable donations, the system including: a) a server computer connected to the Internet; and b) a web application linked to the server, the web application defining a loyalty engine that enables a plurality of merchants to create and manage customized loyalty programs defined by a plurality of rules defined by the loyalty engine for administering their loyalty programs; c) the loyalty engine including a charity utility, the charity utility being operable to enable the operator of the loyalty engine to register one or more charities thereon, the charity utility enabling the plurality of merchants to optionally define the rules under which, as part of their loyalty program, they will make a donation to one or more charities in connection with one or more transactions with a member that is associated with the loyalty program (donation rules); and d) based on a member optionally selecting one or more of the charities, the charity utility being further operable, based on such selection and the donation rules to: i) track transactions between the merchants and the member subject to member's selection for donations; ii) apply the donation rules; and iii) accrue donations to be made by the plurality of merchants to the applicable charities based on one or more transactions between the plurality of merchants and the member.

A computer program comprising computer instructions which when loaded on a server computer connected to the Internet are operable to include: a) A web application defining a loyalty engine that enables a plurality of merchants to create and manage customized loyalty programs defined by a plurality of rules defined by the loyalty engine for administering their loyalty programs; b) the loyalty engine including a charity utility, the charity utility being operable to enable the operator of the loyalty engine to register one or more charities thereon, the charity utility enabling the plurality of merchants to optionally define the rules under which, as part of their loyalty program, they will make a donation to the one or more charities in connection with one or more transactions with a member that is associated with the loyalty program (donation rules); c) based on a member optionally selecting one or more of the charities, the charity utility being further operable, based on such selection and the donation rules to: i) track transactions between the merchants and the member subject to member's selection for donations; ii) apply the donation rules; and iii) accrue donations to be made by the plurality of merchants to the applicable charities based on one or more transactions between the plurality of merchants and the member.

In a very particular aspect of the present invention, the method, system and computer program for providing a loyalty program linked to charitable donations of the present invention provides incentives to charities to encourage their donors to become members, thereby providing merchants with a base of new potential customers.

### BRIEF DESCRIPTION OF THE DRAWINGS

A detailed description of the preferred embodiment(s) is (are) provided herein below by way of example only and with reference to the following drawings, in which:

FIG. 1a is a flowchart summarizing the method of the present invention overall.

FIG. 1b is a system diagram illustrating the resources of the system of the present invention.

FIG. 1c illustrates a particular embodiment of the method of the present invention, according to which a charity is registered to a loyalty program platform.

FIG. 2 illustrates a particular embodiment of the method of the present invention, in accordance with which an individual interested in having donations made on his/her behalf to a particular charity becomes a member.

FIG. 3 illustrates a particular embodiment of the method of the present invention, in accordance with which a new merchant joints the loyalty program platform.

FIG. 4 is a flowchart illustrating the administration of the charity account in accordance with a particular aspect of the present invention.

FIG. 5 provides an overview of the method of the present invention, from the use of the member's financial card to the posting donations based on transactions to the charity account.

FIG. 6 is a flowchart further illustrating the operation of the charity account, and in particular the accrual for the initiated charity donation amounts within a specific accrual period including data for members, merchants and charities.

FIG. 7 is flowchart illustrating the display of the member's reporting within the loyalty system of the present invention for a specific accrual period.

FIG. 8 is a flowchart illustrating the display of the merchant's reporting within the loyalty system of the present invention for a specific accrual period.

FIG. 9 is a flowchart illustrating the display of the charity's reporting within the loyalty system of the present invention for a specific accrual period.

FIG. 10 is a flowchart illustrating the actual donation process at the end of a reporting period including the third party charity and the preparation of tax receipts.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

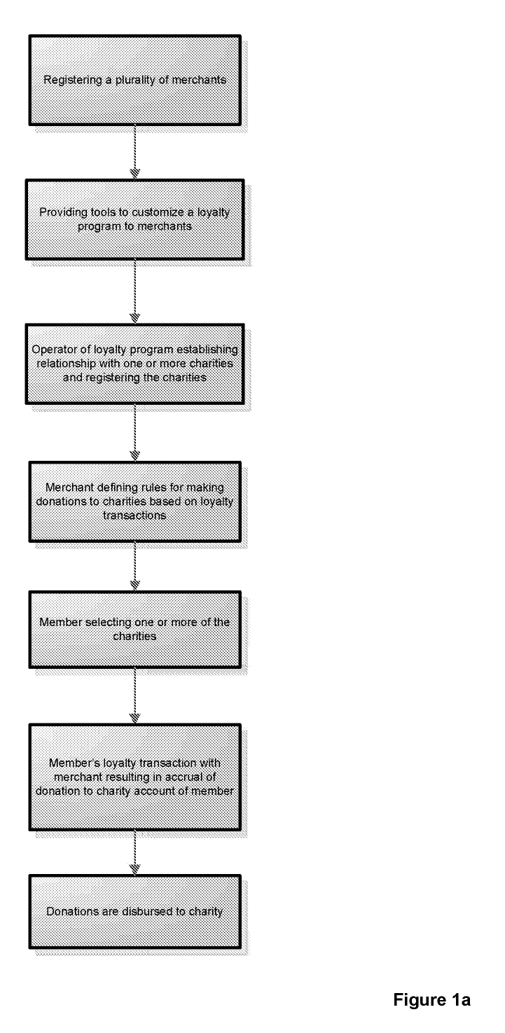

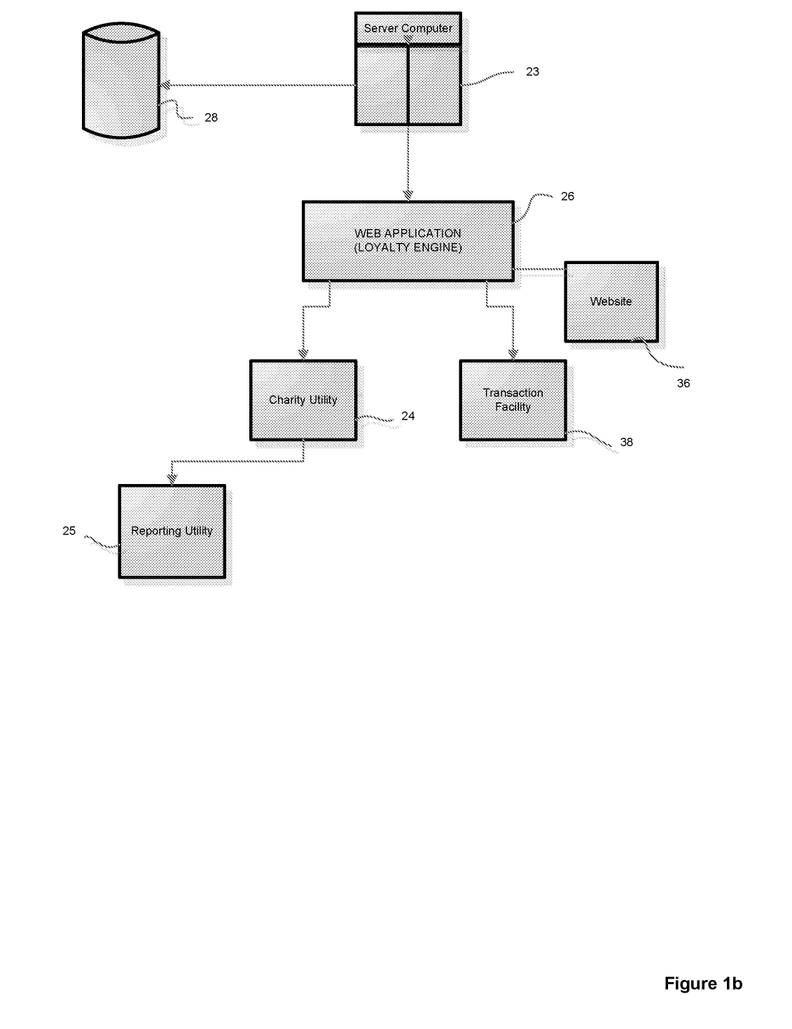

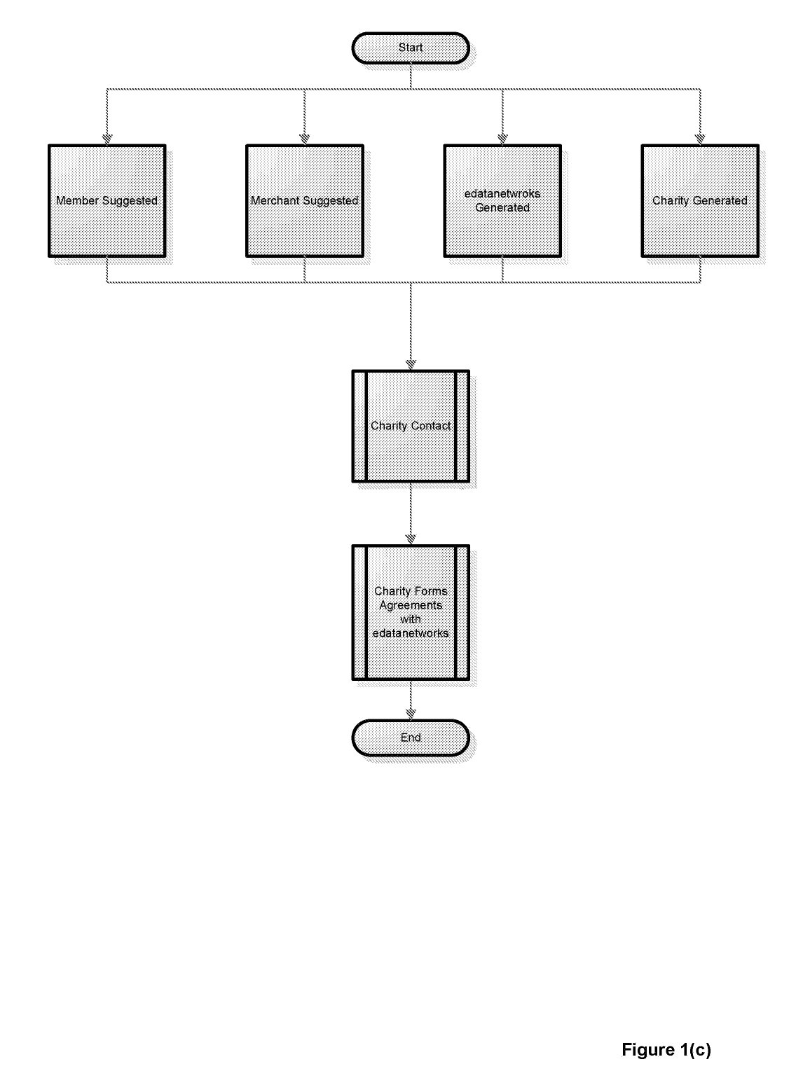

FIG. 1a illustrates the general method of the present invention. A method is illustrated that enables a loyalty program to be linked to charitable donations, involving a loyalty program platform or loyalty engine or loyalty system. The method consists of (10) registering on the loyalty system a plurality of merchants. (12) Providing to the plurality of merchants tools to customize one or more loyalty programs made available to members of the loyalty program platform (customers and potential customers of the merchants). (14) The operator of the loyalty program platform establishing relationships with one or more charities, such relationships determining certain rules under which the plurality of merchants may make donations to the one or more charities based on the activities of members in connection with the loyalty programs. By means of (14), the charities are then registered (16) with the loyalty system (as further illustrated in FIG. 1c). (18) By operation of the loyalty engine, the operator and each participating merchant establishing rules for each participating merchant to make donations to the one or more charities, in conformity with the rules established between the operator and the one or more charities. Typically, the merchants agree to conform to commitments that they make to members that are displayed in the charity area of a website linked to the loyalty system. These commitments are made by merchants by operation of the loyalty engine described in the Co-Pending Patent Application by merchants customizing their loyalty program(s). (20) The members by operation of the loyalty system selecting one or more charities from a list of charities provided by the loyalty system. (22) The loyalty system applying the aforementioned rules as they apply to each participating member so as to process donations based on their applicable transactions within the loyalty system.

In a particular aspect of the present invention, it is not obligatory for members to participate in the donations being made on their behalf to charities. Those who do elect to participate are generally referred to as “participating members” in this particular disclosure.

The loyalty system platform enables each of the merchants, members and charities to track the donation activity.

FIG. 1b best illustrates the system of the present invention. In one particular embodiment thereof, the system is best understood as an extension of the functionality described in the Co-Pending Patent Application, so as to include the charity utility (24) of the present invention, preferably implemented on a server computer (23) connected to the Internet. In one example of an implementation of the charity utility (24) (also referred to as “charity sub-system” in the Figs.), it is best understood as a software component of a web utility that provides the loyalty engine (26) particularized in the Co-Pending Patent Application. The charity utility (24) is programmed in a manner that is known to those skilled in the art, and is operable to provide on the database (28) the charity accounts (30) of the members. Access to different aspects of the database (28) are provided by a known administration utility (32) that provides hierarchical access to the database (28), depending on permissions by the operator of the loyalty system, to each of members, merchants and charities. The purpose of providing this access is to provide transparency to the donations made in operation of the loyalty system, as particularized below. A reporting utility (25) is further linked to the charity utility (24) to provide various reports of interest to merchants and charities in particular, for example, by permitting merchants to generate reports on measured performance of charitable donations made by operation of the loyalty system (thereby enabling calibration of loyalty programs involving charitable donations, as described in the Co-Pending Patent Application) and also permitting charities to generate reports on success of their promotion of the loyalty system to their contacts (including donors), as well as outside factors such as marketing and funding drives thereby also enabling charities to calibrate their use of the loyalty system in a manner similar to the processes described in the Co-Pending Patent Application.

FIG. 1c illustrates the particular steps whereby a charity is registered in accordance with the present invention. Specific charities may be suggested by members, merchants, or other charities. In either case, the operator of the loyalty system selects preferably a group of charities based on a variety of factors. A contract is then entered into between the operator of the loyalty system and the charity. In a particular aspect of the present invention, the operator and the charity agree on joint marketing, and also promotion of a website (36) (illustrated in FIG. 1b) associated with the loyalty system to its contacts such as donors. Specifically, the charity invites its contacts to join the loyalty system as a means to attract new donations to the charity from the merchants participating in the loyalty system (generally referred to as participating merchants). The rights of the operator under the joint marketing understanding with the charity generally includes the right to use trade-marks and promotional materials of the charity (subject to pre-approval) in order to promote the charity's involvement with the loyalty system.

Charities agree contractually to participate in the loyalty system. Merchants also agree to pay participating charities base upon measured performance, as further detailed below.

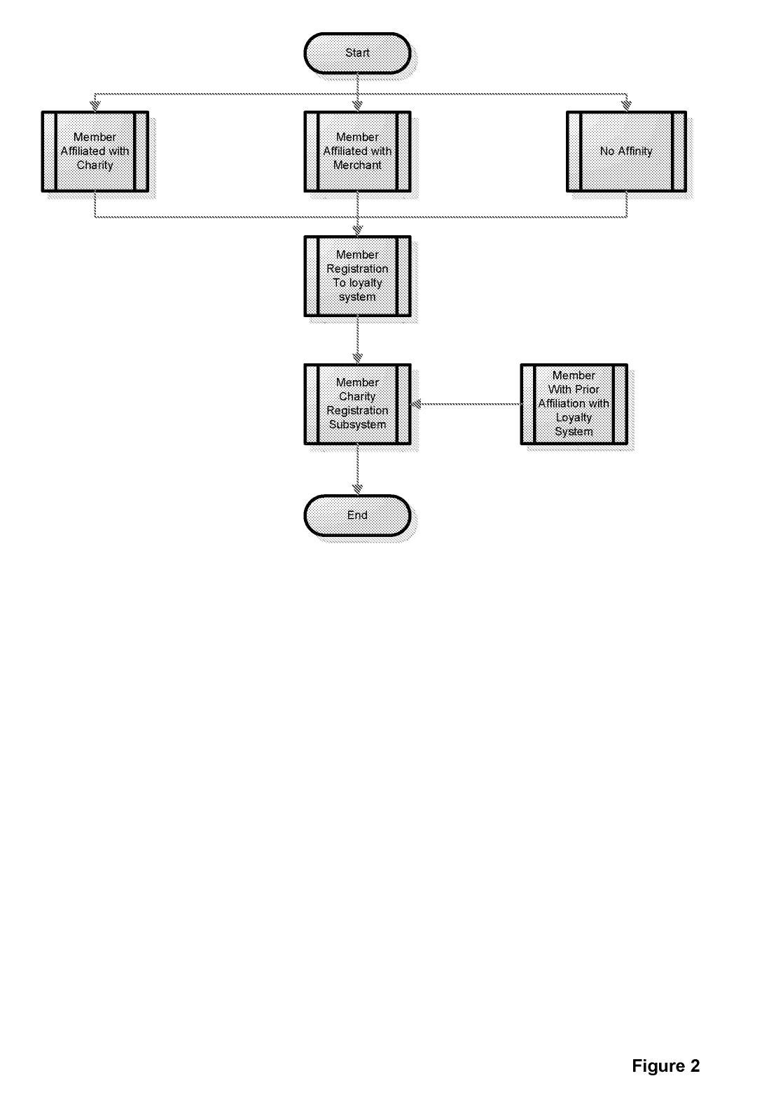

FIG. 2 illustrates a particular embodiment of the method of the present invention, in accordance with which an individual interested in having donations made on his/her behalf to a particular charity becomes a participating member. This can occur in a number of different ways. (A) A member may be affiliated with a charity already. In one aspect of the website (36), a charity area is provided that enables charities to market to its members who may already be donors or aware of the charity. The charity may also use the charity area to generate donations directly from members (i.e. as opposed to donations made by merchants on behalf of members). In a particular aspect of the present invention, the charity utility (24) includes means for processing financial transactions (or transaction utility (38)) between the charity and members. It should also be understood that the transaction utility (38) may also be used to facilitate payments between merchants and charities, including by means of one or more intermediaries between the merchants and the charities, as further explained below.

(B) Merchants may market to their customers to join the loyalty system, to become members and also to become participating members in the charity aspect of the loyalty system. The merchants benefit from increased loyalty and revenue from their customers. The involvement of the charities can enhance these benefits perceived by the merchants.

(C) Promotion of the loyalty system and the website (36) may attract new members who are not associated with the merchants or the charities.

(D) Existing members of the loyalty system may be invited to join the charity area of the loyalty system by the operator of the loyalty system.

It is clear from the above, that members can be attracted to become participating members in a number of different ways. The registration of additional participating members benefits merchants and charities.

In a particular embodiment of the present invention, new members are registered as described in the Co-Pending Patent Application. For example, if a member referred by a charity decides to join the loyalty system, s/he will go to the website (36) to register a financial card and to provide personal information. In the charity area of the website (36), the member preferably indicates how s/he has been referred to the charity area; and whether he/she wishes to have one or more charities receive payments based upon member transactions using a registered financial card. Merchants indicate an amount they will pay to charities based on transactions involving participating members. This is usually reflected in the charity area, so that participating members can patronize merchants based on the donations that they make to charities. This in turn causes a certain level of competition between merchants in their making donations to charities, which in turn tends to benefit charities by increasing their donations overall.

A person may indicate he/she was not referred by a charity but still choose to have a contribution made.

A person, whether referred or not referred, may choose to have no amounts donated to charity. If no charity is designated, the accrual amount is zero for that member's transactions.

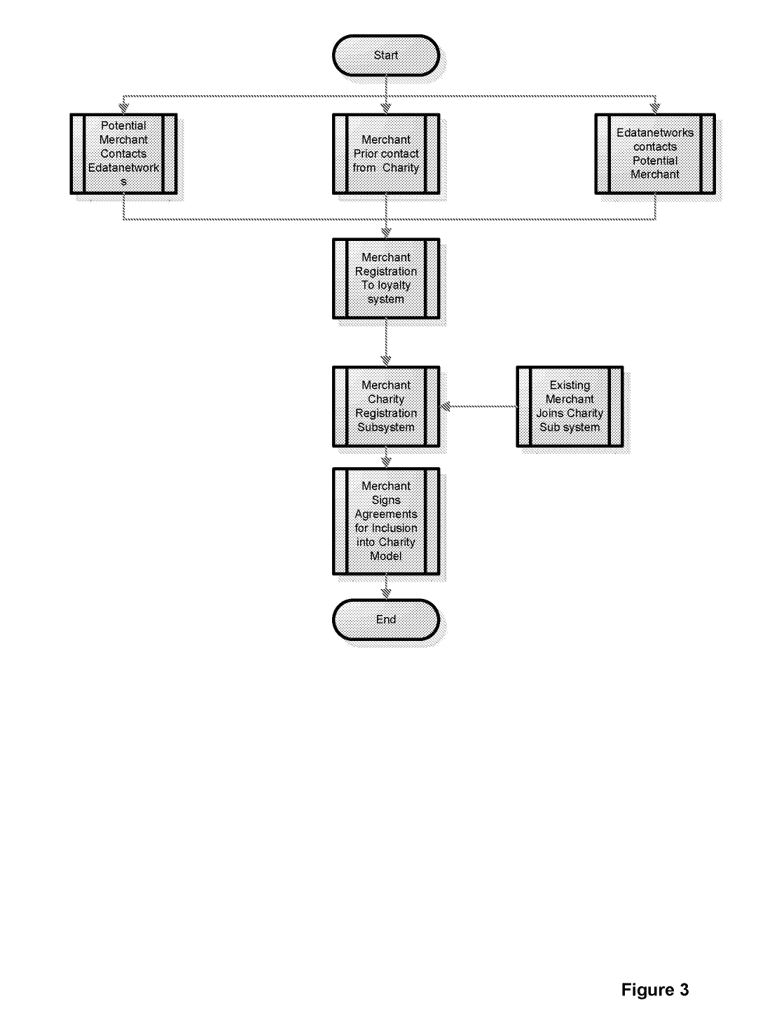

FIG. 3 illustrates the method by which a merchant registers with the charity utility (24). In accordance with a particular aspect of the present invention, a merchant agrees to submit donations based on transactions between the merchants and members, as referenced above. An initial donation rate is set by the participating merchant and the charity utility (24) records the donation rate and applies this towards future transactions between members and the participating merchant.

For example, a merchant “A” agrees to register with the charity utility (24). Merchant “A” enters into an agreement with the operator of the loyalty system to make donations based on transactions within the loyalty system as follows:
1) Min. Transaction Amount=$100.00
2) Date of Transaction (for current and *future accrual periods);
3) Time of Transaction (any time of day);
4) Terminal ID of retail system that captured the financial transaction;
5) SKU number of Item purchased; and
6) Donation Amount based on percentage of Total Transaction Amount (e.g. 1%).

The loyalty system is operable to store the parameters above (and other similar parameters) and apply same against transactions between participating members and participating merchants.

Typically, the parameters or donation rules above are set by each merchant at the beginning of each reporting period. But merchants may vary the donation rules at will, including by time and day of the week for example, provided that this is communicated clearly in the charity area of the web site (36) to members. Accordingly, participating merchants can use the donation rules to encourage specific behaviour from members, e.g. if members attend restaurant X before 6 p.m., then a donation of 2% instead of 1% is paid to charity Y.

In a particular aspect of the present invention, the charity utility (24) is operable to roll over the parameters set out above for future accrual periods. After an accrual period has come to an end the system will verify the accrued amounts of the donations and reset the accumulated displayed totals for each charity, merchant and member to reflect the new accrual period. Certain parameters may be carried forward unless adjusted by the system administrator. The parameters that may be carried forward may include, time period of accrual period, merchant donation rates, member donation distribution, specific charities and merchants involved the charity system.

The donations by merchants are administered by the charity utility (24), and if applicable the transaction utility (38). In most applications, the charity utility (24) allows for the merchant to adjust the percentage of donations for future accrual periods based on member transactions with a registered financial card. Once an accrual period has commenced the donation rate cannot be adjusted for the current accrual period. Future changes by the merchant of donations given to charities may be completed with this utility. For instance a merchant may decide to increase/decrease the percentage used to calculate donations or may decide to base donations strictly on a fixed amount per transaction with a member using a registered financial card.

Following a member's transaction with a merchant, the charity utility (24) is operable to recognize whether a charity amount should be accrued to an applicable charity account (30) based on the donation rules and the member's election. The charity utility (24) is operable to calculate the charitable amount based on the donation rules and then allocate amounts within the charity account (30) based on the various charities designated by the member. The system of the present invention is operable to track: (A) the amount the merchant owes due to all transactions from all members, (B) amount the member has directed to charities (in total) based on various time periods, and (C) the amount accrued to each charity (in total and be each merchant), also over various time periods. The reporting utility (25) is operable to generate various reports based on this tracked data. These amounts are split among charities based on the members' transactions and the directions expressed by each member to share between charities.

In one particular aspect of the present invention, participating merchants contract to pay the donation sum accrued through for each participating charity following the end of a designated accrual period. The loyalty system is operable to provide notice to merchants as to their accrued donation obligations. Similarly, charities are sent reports regarding the amounts that they are expected to receive. Following the period end (about 30 days later) the merchants will pay to the charity or an intermediary (for example a non-profit company responsible for disbursement of donation funds accrued) the applicable amounts. The operator of the loyalty system acts as a trusted intermediary with audit provisions in place with the merchants and the charities (subject to protection of personal information of all individuals concerned) to enable merchants to make donations accrued for all members who transacted with them at once, and also for charities to receive donations for all members who designated them at once.

As an alternative each merchant may make payments to each participating charity, as applicable, including by operation of the transaction utility (38).

In a particular aspect of the present invention, each merchant preferably maintains donation terms constant within a set period of time. This is to provide efficiency in communications (sending an update as to a change each time it occurs would be cumbersome to all concerned) and predictability in the relevant transactions.

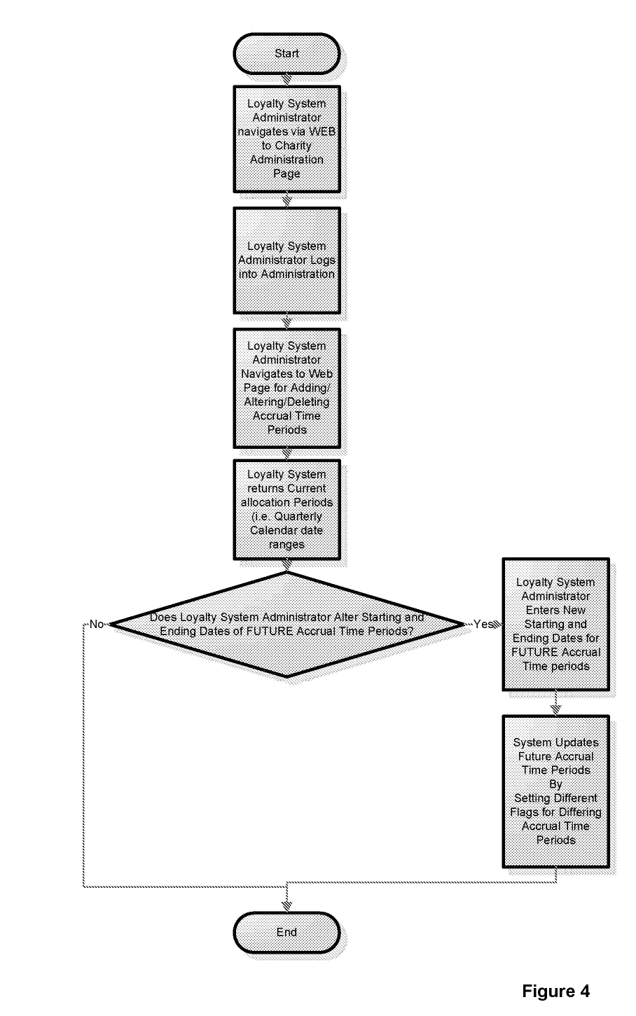

As illustrated in FIG. 4, the charity utility (24) establishes accrual periods, based on rules established by the operator of the loyalty system. The starting times and ending times for the accrual periods define donation time periods, which form boundaries for all agreements and donation related activities. The purpose of the accrual periods is to create time boundaries for donation generation.

For example, the operator of the loyalty system may establish twelve accrual periods in any year which correspond to the months of the year. Later, the operator of the loyalty system may change the accrual periods by having four quarterly accrual periods. The charity utility (24) is operable to add flags to new transactions to that they are tagged for the appropriate accrual period in the database (28). In this implementation of the present invention, the system only permits changes to the accrual period for future time intervals. Therefore no changes can be made when the current date/time is within a current accrual period.

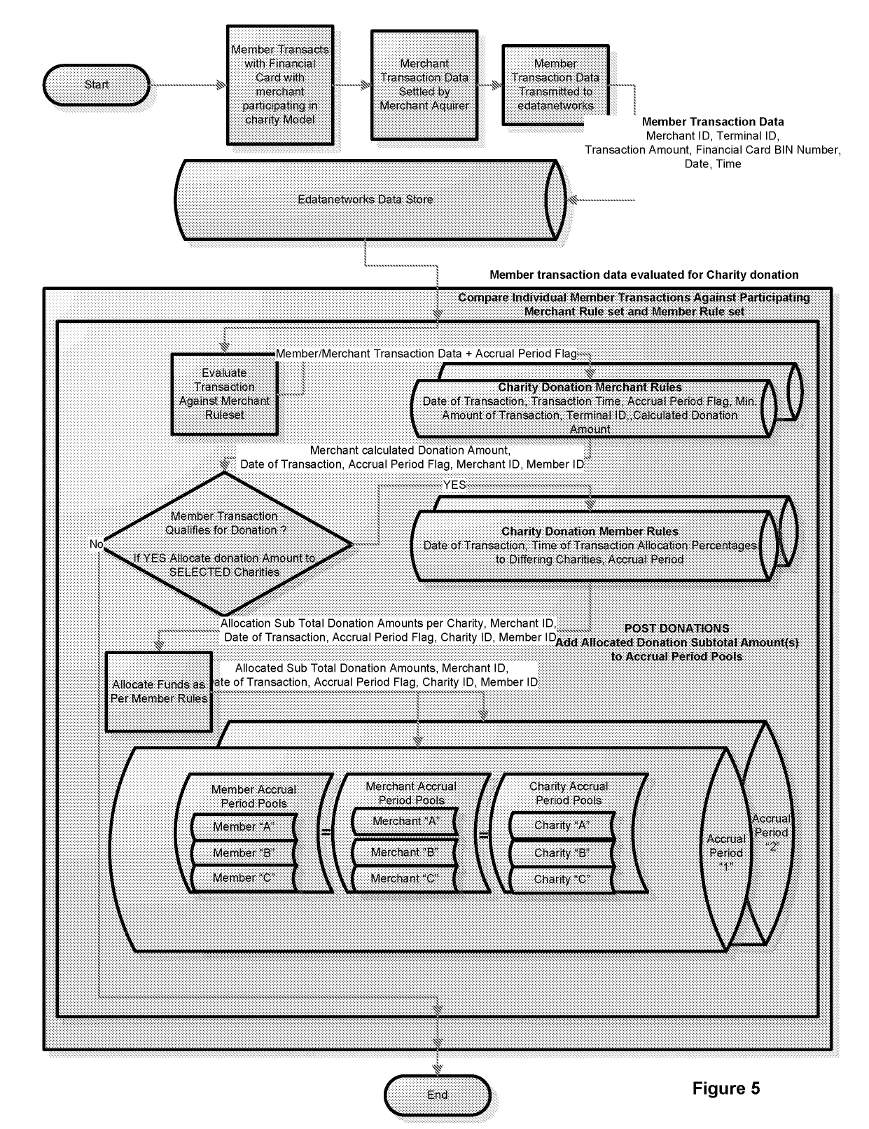

FIG. 5 illustrates in greater detail the operation of the present invention as described above, end to end. FIG. 5 also illustrates the manner in which transactions are flagged, and donations are accrued. As illustrated in FIG. 5, the charity utility (24) is operable to evaluate transaction information received by the loyalty system to ensure that they are in compliance with the applicable donation rules, in order to determine whether a donation should be processed in a particular transaction.

### Examples in Operation

In operation, assume that the operator of the loyalty system has set the following parameters for the accrual periods: Jan. 01, 2005-Mar. 31, 2005; Accrual Period 2: Apr. 01, 2005-Jun. 30, 2005; Accrual Period 3: Jul. 01, 2005-Sep. 31, 2005; and Accrual Period 4: Oct. 01, 2005-Dec. 31, 2005.

For Example Merchant “A” sets the following parameters for Accrual Period 1:

1) Min. Transaction amount $100.00
2) Transaction must be made between Jan. 01, 2005-Mar. 31, 2005

### 3) Any Time for a Transaction

4) Any Terminal ID of retailers that captures the financial transaction

### 5) Any SKU

### 6) 1% of Total Transaction Amount

Suppose the following transaction data is relayed to the loyalty system:

### Transaction #1 Member “H”:

### 1) Transaction Amount 240.00

### 2) Transaction Date Jan. 02, 2005

### 3) Transaction Time 09:53 AM

### 4) Terminal ID 232596

### 5) SKU Not Relayed

### Transaction #2: Member “I”

### 1) Transaction Amount 96.43

### 2) Transaction Date Jan. 02, 2005

### 3) Transaction Time 10:52 AM

### 4) Terminal ID 987654

### 5) SKU 0909579

### Transaction #3: Member “J”

### 1) Transaction Amount 9800.00

### 2) Transaction Date Dec. 10, 2005

### 3) Transaction Time 11:52 AM

### 4) Terminal ID 987684

### 5) SKU 123456

The donation amount that the merchant would owe would be calculated as the following:

Transaction “A” 240.00×1%=$2.40

Transaction “B”=$0.00 NOT WITHIN DATE RANGE

Transaction “C”=9800.00×1%=98.00

Total Donation Generated (Merchant obligation)=97.85+2.40=$100.25

The Members have each set the following parameters:

### Member “H”:

### 25% to Charity “AA”

### 25% to Charity “BB”

### 50% to Charity “CC”

### Member “I”:

### 100% to Charity “AA”

### Member “J”:

### 50% to Charity “AA”

### 50% to Charity “BB”

The distribution to each charity form the Member/Customer transactions would be:

### Member “H” Transaction:

### 25% of 2.40=$0.60 to Charity “AA”

### 25% of 2.40=$0.60 to Charity “BB”

### 50% of 2.40=$1.20 to Charity “CC”

### Member “I” Transaction:

### 100% of $0.00 to Charity “AA”

### Member “J” Transaction:

### 50% of $98.00=$49.00 to Charity “AA”

### 50% of $98.00=$49.00 to Charity “BB”

The Total donation Generated for each charity is:

### Charity “AA” $0.60+$49.00=$49.60

### Charity “BB” $0.60+$49.00=$49.60

### Charity “CC”=$1.20

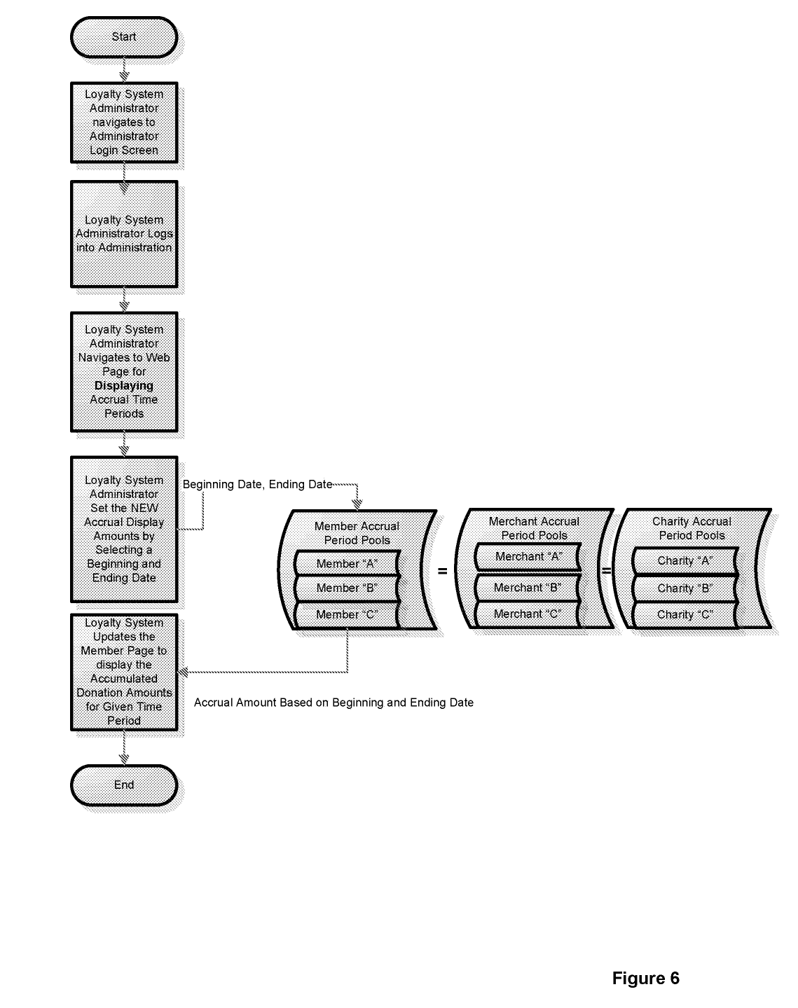

FIG. 6 illustrates the operation of the charity account (30), and in particular the accrual for the initiated charity donation amounts within a specific accrual period including data for members, merchants and charities. The operator of the loyalty system chooses a date range for displaying to members the total amount generated by member transactions with participating merchants. The total amount reflects the donation amounts accrued within a set time period. The time period is chosen by the system administrator and reflects the entire donation amount generated for all charities. For example: Member “I” creates $20.00 in donations within Jan. 1, 2005 and Mar. 31, 2005; and Member “2” creates $25.00 in donations within Dec. 1, 2004 and Dec. 31, 2004. The operator of the loyalty system chooses the following dates for display of member generated donations: beginning date=Jan. 1, 2005; and ending date=Dec. 31, 2005. The system would display $25.00 for donations generated if these were the only members who made qualifying transactions for the administrator selected time period.

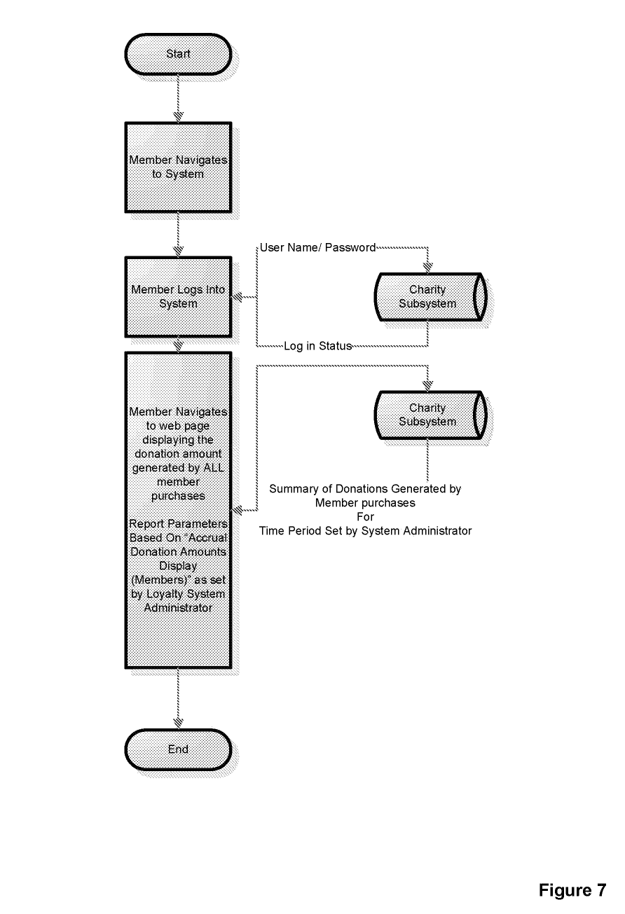

FIG. 7 illustrates the display of the member's reporting within the loyalty system of the present invention for a specific accrual period. For example, members have the option to view the total accumulated donations generated by all members. The system allows for the viewing of the total amounts for the purpose of increasing the sense of community for members, and also a healthy sense of competition between them, thereby benefiting charities. For instance a member may choose to navigate to an area of the system that shows that the total accumulated donations generated for a time period determined by the operator of the loyalty system is $1000.00.

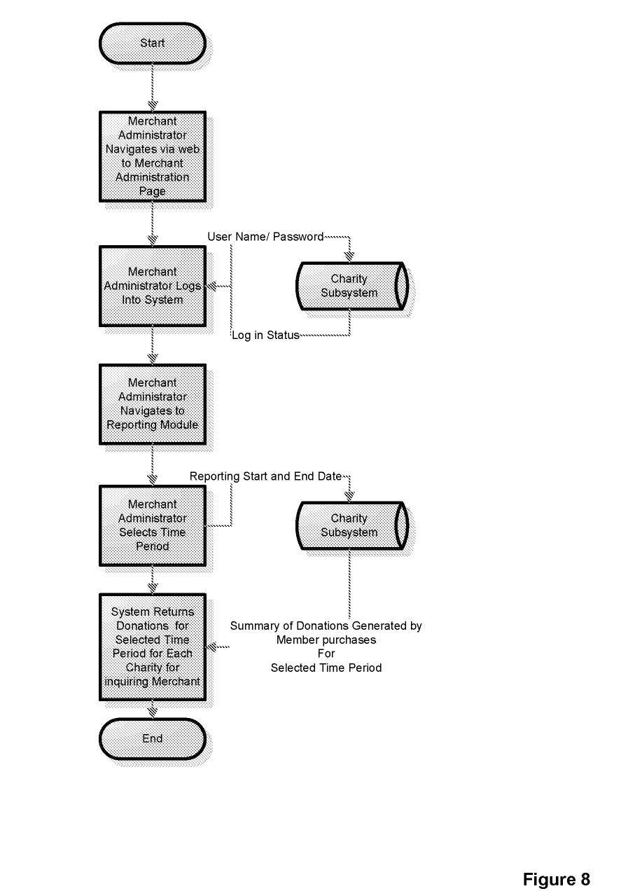

FIG. 8 is a flowchart illustrating the display of the merchant's reporting within the loyalty system of the present invention for a specific accrual period. Merchants who are participating in donation generation have the option to view donation amounts that are due to charities. The participating merchant may view the amounts due to the various charities due to transactions by members with the participating merchant. This allows for the merchant to monitor donation amounts due to each charity that the members have chosen. For instance a Merchant “A” may wish to view the donations created between Jan. 1, 2005 and Mar. 31, 2006, by operation of reporting utility (25). The system would return a breakdown of the amounts due to each particular charity. The system only allows each merchant to view their own donation obligation and not amounts that other merchants owe.

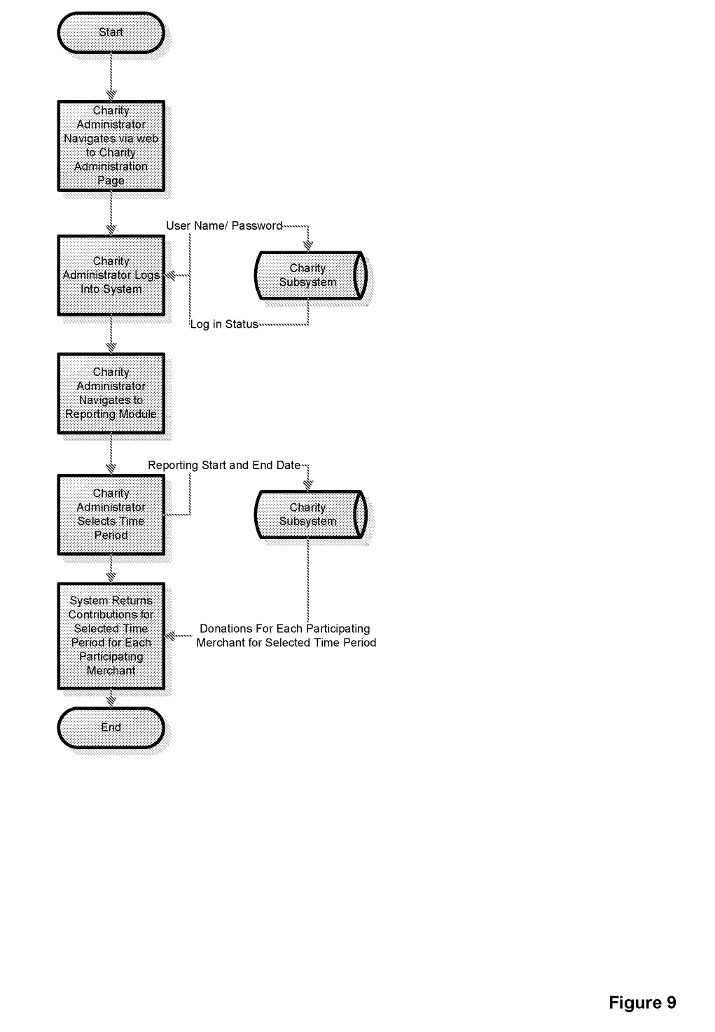

FIG. 9 is a flowchart illustrating the display of the charity's reporting within the loyalty system of the present invention for a specific accrual period. The system allows for each charity to monitor the donation amount due by merchant. Currently there a few means for a charity to monitor donation amounts promised by merchants for various consumer purchases. The system allows for the charity to view the amounts due to it by merchant within a selected time period by operation of reporting utility (25).

For instance a Charity “AA” may wish to view the donations due to it for consumer/member transactions within the date range of Jan. 1, 2005 to Mar. 31, 2006. The system would return the breakdown by merchant on how much they owe to the charity. Using the information from FIG. 8:

### Merchant “AA” $10.00

Each charity has their own view of donation generation reporting (by operation of the reporting utility (25)) and may not view other charity donations by operation of the administration utility (32).

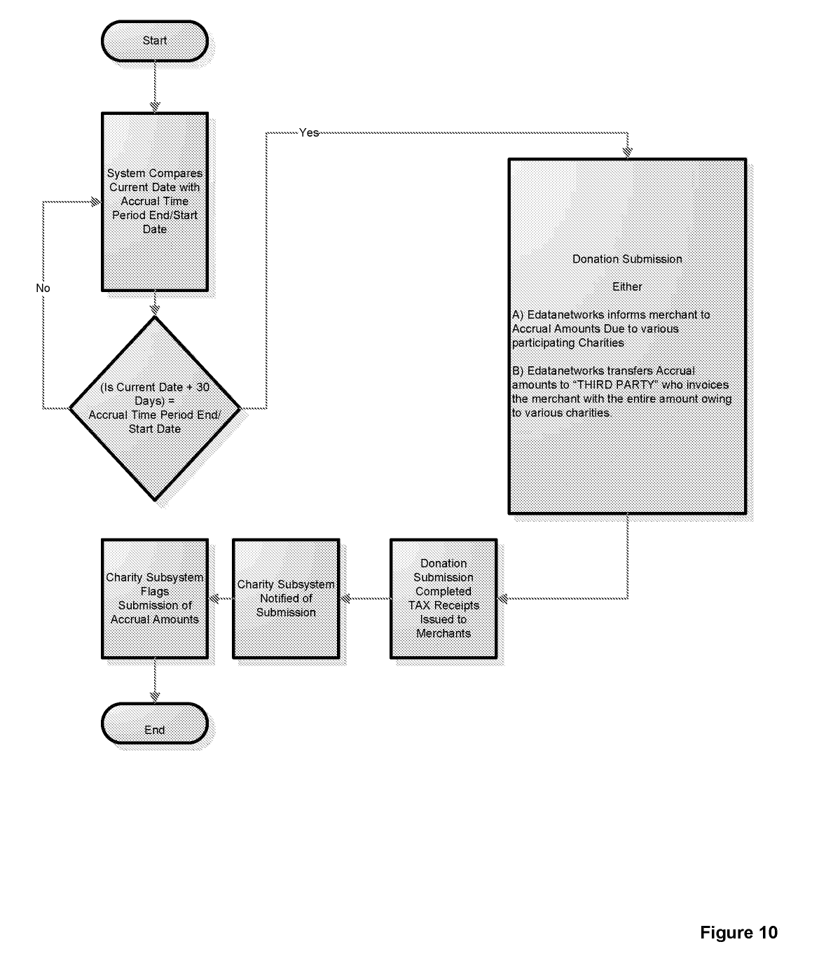

FIG. 10 is a flowchart illustrating the actual donation process at the end of a reporting period including the third party charity and the preparation of tax receipts. This is intended merely as an example of how this part of the method might work, depending on applicable legal and administrative requirements. In another implementation of this aspect of the invention, the merchants send payment directly for each accrual period for each participating charity, and the participating charities issue tax receipts directly.

It should be understood that the cost of acquiring new customers is generally quite high, and this is a cost that merchants tend to monitor very closely. Particularly if a merchant's relationship with a charity in the context of the loyalty system permits the merchant to acquire a new customer through the charity, merchants will generally be willing to make a relatively significant donation to the charity that resulted in the new customer. In addition, the present invention enables a merchant to build more links with a community by making donations to local charities by operation of the present invention. This provides invaluable public relations with local communities. This represents a particularly strong opportunity to merchants who have no or little physical presence in a particular geographic area.

Other implementations and extensions of the invention are possible. For example, it should be understood that the present invention contemplates use of various security methods and technologies for restricting access to resources of the loyalty system to those authorized to do so by the operator of the loyalty system; the use of various existing and future technologies to process payments by operation of the transaction utility (38); various tools and interfaces for interacting with the loyalty system in accordance with the method of the present invention. The system also allows for robust reporting which may include comparative reports of member affinity (member may be referred by a charity) of transaction history with participating merchants. In other words, member transaction history may be different for differing groups of members based on member affinity.

What is claimed is:

1. A method for providing a loyalty program linked to charitable donations comprising the steps of:
(a) Each of a plurality of merchants creating a customized loyalty program defined by a plurality of rules for administering their loyalty program;
(b) Linking one or more charities with the loyalty programs;
(c) The plurality of merchants defining the rules under which, as part of their loyalty program, they will make a donation to one or more charities in connection with one or more transactions with a member that is associated to the loyalty program (donation rules);
(d) The member optionally selecting one or more charities presented to the member that, as part of their participation in the loyalty program, the plurality of merchants shall make a donation to the selected charities in connection with transactions between the member and the plurality of merchants; and
(e) Tracking the transactions subject to the member's selection, applying the donation rules, and making the applicable donations available to the one or more charities.

2. The method of claim 1, whereby the member is presented with a list of the one or more charities and invited to select one or more of the charities, as well as a percentage of donations that shall be made to each of such charities in connection with the transactions.

3. The method of claim 2, whereby a charity account is associated with each member for applying the donation rules over time and cumulatively recording donations to be made over time.

4. The method of claim 1, comprising the further step of the one or more charities promoting the loyalty program to their contacts.

5. The method of claim 1, whereby the donation rules define the particulars of transactions with the member that will result in a donation being made to the one or more charities, such particulars including size of transaction, product or services associated with the transaction, time of the transaction, or the requirement that the transaction be with a member who is a new customer of the merchant.

6. The method of claim 1, whereby a plurality of reporting periods is defined for the donation rules, such that the plurality of merchants may make changes to the donation rules for a future reporting period before a specified date, but after the specified date the donation rules remain static.

7. The method of claim 1, comprising the further step of providing access to the merchant to a reporting tool that enables the merchant to obtain reports regarding their accrued donation obligations over specified time periods, and/or data regarding incremental cost regarding their accrued donation obligations to make donations for a specified period of time.

8. The method of claim 1, comprising the further step of providing access to the member to a reporting tool that enables the member to view data regarding the donations made on his/her behalf over specified time periods to the one or more charities, based on the member's election(s).

9. The method of claim 1, comprising the further step of providing access to the one or more charities to a reporting tool that enables the one or more charities to view data regarding the accrued donation obligations owed to them in connection with the loyalty program.

10. A system for providing a loyalty program presented by a plurality of merchants to a plurality of members registered with the loyalty program, the loyalty program being linked to charitable donations, the system comprising:
(a) a server computer connected to the Internet; and
(b) a web application linked to the server, the web application defining a loyalty engine that enables a plurality of merchants to create and manage customized loyalty programs defined by a plurality of rules defined by the loyalty engine for administering their loyalty programs;
(c) the loyalty engine including a charity utility, the charity utility being operable to enable the operator of the loyalty engine to register one or more charities thereon, the charity utility enabling the plurality of merchants to optionally define the rules under which, as part of their loyalty program, they will make a donation to one or more charities in connection with one or more transactions with a member that is associated with the loyalty program (donation rules); and
(d) based on a member optionally selecting one or more of the charities, the charity utility being further operable, based on such selection and the donation rules to:
(i) track transactions between the merchants and the member subject to member's selection for donations;
(ii) apply the donation rules; and
(iii) accrue donations to be made by the plurality of merchants to the applicable charities based on one or more transactions between the plurality of merchants and the member.

11. The system claimed in claim 10, wherein the loyalty engine further includes a transaction utility that is operable to transmit funds corresponding to the donations owed by merchants based on the donation rules to the charities.

12. The system claimed in claim 10, wherein the system computer is linked to a database, and the charity utility defines on the database a charity account for each member applying the donation rules over time and cumulatively recording donations to be made over time.

13. The system of claim 10, wherein the charity utility is operable to present to the member the option of selecting between the one or more charities, and defining the percentage of donations that shall be made to each of such charities in connection with the transactions.

14. The system of claim 10, wherein the donation rules define the particulars of transactions between the merchants and the member that will result in a donation being made to the one or more charities, such particulars including size of transaction, product or services associated with the transaction, time of the transaction, or requirement that the transaction be with a member who is a new customer of the merchant.

15. The system as claimed in claim 14, wherein the charity utility enables merchants to dynamically modify the donation rules to conform to their business objectives, including to optimize the donation rules to improve their return on investment.

16. The system of claim 10, wherein the charity utility enables the operator of the loyalty engine to define a plurality of reporting periods for donation rules, such that the plurality of merchants may make changes to the donation rules for a future reporting period before a specified date, but after a specified date the donation rules remain static.

17. The system of claim 10, method of claim 1, comprising the further step of providing access to the merchant to a reporting tool that enables the merchant to obtain reports regarding their accrued donation obligations over specified time periods, and/or data regarding incremental cost regarding their accrued donation obligations to make donations for a specified period of time.

18. The system of claim 10, wherein the charity utility is linked to a reporting facility, the reporting facility enabling:
(a) the member to view data regarding the donations made on his/her behalf over specified time periods to the one or more charities, based on the member's election(s);
(b) the charities to view data regarding the accrued donation obligations owed to them in connection with the loyalty program; and the
(c) merchants to view data regarding their accrued donation obligations, and past donations.

19. A computer program comprising computer instructions which when loaded on a server computer connected to the Internet are operable to provide:
(a) A web application defining a loyalty engine that enables a plurality of merchants to create and manage customized loyalty programs defined by a plurality of rules defined by the loyalty engine for administering their loyalty programs;
(b) the loyalty engine including a charity utility, the charity utility being operable to enable the operator of the loyalty engine to register one or more charities thereon, the charity utility enabling the plurality of merchants to optionally define the rules under which, as part of their loyalty program, they will make a donation to the one or more charities in connection with one or more transactions with a member that is associated with the loyalty program (donation rules);
(c) based on a member optionally selecting one or more of the charities, the charity utility being further operable, based on such selection and the donation rules to:
(i) track transactions between the merchants and the member subject to member's selection for donations;
(ii) apply the donation rules; and
(iii) accrue donations to be made by the plurality of merchants to the applicable charities based on one or more transactions between the plurality of merchants and the member.

20. The computer program claimed in claim 19, further comprising a transaction utility that is operable to transmit funds corresponding to the donations owed by merchants based on the donation rules to the charities.
